(19) United States
(12) Patent Application Publication
(10) Pub. No.: US 2024/0408512 A1
(43) Pub. Date: Dec. 12, 2024

(54) MIXING KNEADER AND METHOD FOR CARRYING OUT AN EXTRACTION

(71) Applicant: LIST TECHNOLOGY AG, Arisdorf (CH)

(72) Inventor: Pierre-Alain Fleury, Ramlinsburg (CH)

(73) Assignee: LIST TECHNOLOGY AG, Arisdorf (CH)

(21) Appl. No.: 18/701,821

(22) PCT Filed: Oct. 17, 2022
(86) PCT No.: PCT/EP2022/078793

§ 371 Date: Apr. 16, 2024

(30) Foreign Application Priority Data
Oct. 19, 2021 (DE) 10 2021 127 051.0

(51) Int. Cl. B01D 11/02; B01F 23/50; B01F 23/53; B01F 23/80; B01F 27/60; B01F 27/702; B01F 27/707; B01F 35/75; B01F 35/90; B01F 35/93; B01F 101/00; B01J 20/22; B01J 20/30

(52) U.S. Cl. CPC B01D 11/0226; B01D 11/0288; B01F 23/53; B01F 23/58; B01F 23/59; B01F 23/80; B01F 27/62; B01F 27/702; B01F 27/707; B01F 35/754551; B01F 35/93; B01J 20/22; B01J 20/3071; B01F 2035/99; B01F 2101/2204; B01F 2215/0422; B01F 2215/0427

(57) ABSTRACT

Mixing kneader (1) for carrying out a continuous extraction in which, with the aid of an extractant, at least one component is released from an extraction material, the mixing kneader (1) comprising a working space (2), at least one shaft (14) extending in the working space (2), the at least one shaft (14) comprising shaft superstructures (11, 12, 29) in the form of kneading elements, wherein the shaft superstructures (11, 12, 29) of the at least one shaft (14) are configured to mesh during operation with the shaft superstructures (11, 12, 29) of at least one second shaft (14) or with stationary kneading elements (17) present in the mixing kneader (1), a first feed device (4) for feeding the extraction material into the mixing kneader (1), and a first discharge device (3) which lies substantially opposite the first feed device (4) and discharges the extraction residue, is intended to be characterized by a second feed device (6) for feeding the extractant, wherein this second feed device (6) is arranged substantially opposite the first feed device (4), further characterized by a second discharge device (5) for discharging the extract solution, wherein the second discharge device (5) is arranged substantially opposite the first discharge device (3), wherein the second discharge device (5) comprises a device for mechanical separation.

### TECHNICAL FIELD

The invention relates to a mixing kneader and method for carrying out an extraction.

### PRIOR ART

The extraction for the purpose of drying a superabsorbent polymer is known for example from EP 0 994 734 B1. This document discloses the preparation of a superabsorbent polymer which is dried in a batch process with the aid of acetone.

Mixing kneaders are also known from the prior art.

### SUMMARY OF THE INVENTION

The object of the present invention consists in providing an improved mixing kneader and an improved method for carrying out an extraction.

The subject matter disclosed herein leads to the solution to the problem. Advantageous embodiments are also described herein.

A mixing kneader according to the invention for carrying out a continuous extraction, in which, with the aid of an extractant, at least one component is dissolved from an extraction material, comprises a working space and at least one shaft that extends in the working space. The extraction material is typically a substance mixture comprising at least two components. The component to be dissolved, i.e. to be removed from the extraction material, can also be referred to as the extractive.

Within the context of the present invention, an extraction is understood to be any separating method in which at least one component to be dissolved is released from the extraction material, at least in part, with the aid of the extractant.

The extractant is preferably a liquid, wherein it can be a pure substance or a liquid mixture.

The extraction material can in particular be a liquid or a solid or a mixture comprising at least one solid and at least one liquid. The component to be dissolved (extractive) can for example be present dissolved or emulsified or suspended or adsorbed in the liquid extraction material, depending on the type and quality of both substances, and depending on whether the extractive is a solid or a liquid. However, the component to be dissolved can other be otherwise bound to the component of the extraction material that later remains as the extraction residue.

Within the context of the present invention, the term “extraction” is also intended to cover methods in which the component to be extracted undergoes a chemical reaction, i.e. for example is chemically modified by the extractant. The chemical reaction can bring about the release of the component from the reaction product and/or can take place after the release of the component, in order for example to bring about a concentration gradient that drives the extraction.

In this case, the term “working space” preferably denotes the interior of the mixing kneader. Said interior is usually round in cross section in the case of single-shaft mixing kneaders, and usually configured as a recumbent (digit) eight in cross section in the case of twin-shaft mixing kneaders. The working space thus preferably comprises the space in which the at least one shaft rotates, but not attachments, such as a dome which is optionally provided and is described in greater detail below. Within the context of the present invention, the designation “dome” relates primarily to the structure of known domes, but not necessarily to their function. Domes known from mixing kneaders are typically not filled with the mixture to be processed, but rather only with the gas or vapour phase thereabove. Within the context of the present invention, however, a structure placed on the working space, which is similar, in terms of design, to known domes, is also referred to as a dome, irrespective of its function. This also applies irrespective of where this dome is attached to the working space and how it is oriented. As will be explained in detail again below, the second discharge device can be located in the dome.

Thus, exactly one mixing shaft can extend in the working space. However, it can also be conceivable to use exactly two or more mixing shafts. Preferably, either exactly one or exactly two mixing shafts are used. If exactly one mixing shaft is provided, then this is a single-shaft mixing kneader, which is described for example in CH 674 472 A5. In this case, shaft structures of the mixing shaft preferably mesh, during operation, with stationary attachments of the housing, for example what are known as counter hooks. If exactly two mixing shafts are provided, then this is a twin-shaft mixing kneader, which is described for example in DE 41 18 884 A1. The shaft structures of the mixing shafts preferably mesh with one another during operation.

The at least one shaft comprises shaft structures in the form of kneading elements, wherein the shaft structures of the at least one shaft are preferably configured to mesh, during operation, with the shaft structures of at least one second shaft or with stationary kneading elements present in the mixing kneader. Mixing kneaders having elements that mesh in this way are known and are designated “self-cleaning”, because the described meshing releases any deposit build-ups on the meshing elements. Stationary kneading elements in the interior of the mixing kneader are sometimes also referred to as “mating elements”, hook-shaped stationary kneading elements are referred to as “counter hooks” or “kneading counter hooks”.

Kneading elements within the meaning of the present invention are in particular bars, counter hooks, T-shaped fingers, and the like. The term “kneading elements” includes all stationary elements (i.e. fixed to the housing) and rotating elements (i.e. fixed to the shaft), which can bring about kneading or thorough mixing of the substance (mixture) to be treated in the mixing kneader. Preferably, the kneading element pass one another during the rotation of the shaft, particularly preferably in a meshing manner.

The above-described shafts comprising kneading elements are known from the prior art, for example from DE 41 18 884 A1, wherein the kneading elements are bars which are mounted on discs which are in turn fixed to the shaft. For the present invention, the way in which the kneading elements are fixed to the shafts is irrelevant. If bars and discs (also referred to as “supports”) are used, then these can for example also be manufactured in one piece—the term “fixed” is thus to be interpreted broadly. While the above-mentioned DE 41 18 884 A1 discloses a twin-shaft mixing kneader, CH 674 472 A5 discloses a single-shaft mixing kneader comprising hook-like stationary kneading mating elements (known as “kneading counter hooks”) on the inner wall of the housing. The housing, shaft(s), shaft structures and stationary kneading mating elements can be configured as described in the above-mentioned documents.

The mixing kneader according to the invention further comprises a first input device for feeding the extraction material into the working space, and a first discharge device which lies substantially opposite the first input device and is intended for discharging the extraction residue. A “discharge device which lies substantially opposite” preferably relates to the axial extension of the mixing kneader, and therefore preferably means “opposite in the longitudinal direction”.

The mixing kneader can also comprise a plurality of first input devices. Further substances can also be fed into the working space via said at least one first input device. By way of example, reference is made here to the precipitant, binder, flocculant and flocculating aid, explained in greater detail below. However, as will be explained in more detail below, the extractant is not fed in via the first input device, but rather via a second input device, which will also be explained in greater detail below.

A conveying direction of the extraction material extends from the first input device to the first discharge device. With reference to this conveying direction, an input side and a discharge side of the mixing kneader can be defined, which relate to the input of the extraction material and the discharge of the extraction residue. The input and discharge side in each case comprises half of the mixing kneader in the longitudinal direction. The first input device and a second discharge device, described in greater detail below, are arranged within the input side, while the first discharge device and a second input device, described in greater detail below, are arranged within the discharge side.

While the extraction material passes through the mixing kneader in the conveying direction, it continuously delivers the at least one component, to be dissolved, to the extractant. After completely passing through the mixing kneader in the conveying direction, the extraction material is then referred to as the extraction residue.

Correspondingly the extractant, which passes through the mixing kneader counter to the conveying direction of the extraction material, is continuously enriched with the component to be dissolved (the extractive). After completely passing through the mixing kneader counter to the conveying direction of the extraction material, the extractant is correspondingly referred to as the extract solution.

The mixing kneader further comprises the second input device for feeding the extractant, wherein this second input device is arranged substantially opposite the first input device. In this case, opposite means in any event that the second input device is arranged within the discharge side, while the first input device is arranged within the input side.

The mixing kneader can comprise a plurality of first input devices, which are arranged within the input side. Said first input devices can be arranged along an imaginary longitudinal axis of the mixing kneader, but always within the input side.

The mixing kneader further comprises the second discharge device for discharging the extract solution, wherein this second discharge device is arranged substantially opposite the first discharge device. Within the context of the present invention, reference is often made to an extract solution, since the component to be extracted generally dissolves in the extractant. In rare embodiments, the at least one component to be extracted can be dissolved from the extraction material and can form a substance mixture, for example an emulsion or a suspension, together with the extractant. Such an emulsion, suspension or the like is nonetheless intended, in the context of the present invention, to be covered by the term “extract solution”.

The above-mentioned complete passing through means, with reference to the extraction material and the extraction residue, reaching the first discharge device, and, with reference to the extractant and the extract solution, reaching the second discharge device.

The above-described arrangement of the devices, arranged opposite one another in each case, makes it possible to achieve counterflow extraction. In this case, “opposite” always refers to the imaginary longitudinal axis of the mixing kneader.

The second discharge device comprises a device for mechanical separation, wherein this is intended in particular to mean the three following embodiments of such a device. In this case, any devices are possible which are suitable for separating the components of inhomogeneous mixtures from one another. Usually, the components to be separated are solid or liquid, wherein it is also possible for a component to be present as a solid and as a liquid. Since this is preferably the separation of the extraction material just fed in, from the extract solution already enriched with the extractive, it is usually a device for separating solids from liquids.

The device for mechanical separation can firstly be a filter. A filter of this kind can prevent the penetration of particles into the second discharge device.

Secondly, the arrangement of the second discharge device can form a device for mechanical separation within a dome, which will be described in greater detail in the following. For this purpose, an inlet opening of the second discharge device, through which the extract solution to be delivered penetrates into the second discharge device, is preferably arranged at the top, in the dome. Other arrangements are for example possible if the dome is arranged at the bottom, on the mixing kneader, i.e. below the working space.

In the case of a dome arranged above the working space, the mechanical separation can be brought about simply by the spacing between the inlet opening, located at the top in the dome, and the working space. Furthermore, the inlet opening can be arranged centrally in the dome, and any particles penetrating into the dome can be conveyed onto an inside wall of the dome by generation of a flow. The particles conveyed onto the inside wall of the dome can sink down there. In this way, only or very predominantly particle-free extract solution enters the inlet opening.

Coils can be provided in the dome, which coils can convey penetrating particles and preferably prevent penetration into the second discharge device. In the case of such a device for mechanical separation, provided by the arrangement of the second discharge device within the dome, coils and preferably a screw can be used, as is explained in greater detail in the description of the figures.

The coils can prevent penetration of particles into the second discharge device.

Such coils can in particular be used if the density of the extraction material or of the particles is only slightly greater than or approximately equal to the density of the extractant.

Furthermore, thirdly, a device is conceivable which is fluidically connected to the working space of the mixing kneader and preferably operates continuously, which device is configured as a decanting or sedimentation container. The use of cascades of such containers and/or the use of centrifuges is also conceivable. A devices of the kind serves on the one hand for mechanical separation by deposition, sedimentation and/or decanting, and on the other hand as a second discharge device for the extract solution.

In this case, the term “decanting” is not limited to mixtures of two liquids present separately from one another, but rather also includes the removal for example of a liquid after a solid, dissolved in said liquid, has been deposited by sedimentation.

Other devices, such as a, preferably continuously operating, centrifuge or ultracentrifuge are also possible as a device for mechanical separation.

If the particles do not sink down when using the arrangement described above under “secondly”, but rather collect within the dome, the following measures are possible, which are conceivable individually or in combination:
The density of the particles can be increased. If the extraction material is a polymerizate, then for example the molecular weight of the polymer can be increased by adjusting the polymerisation conditions.
The density of the extractant can be reduced, in that a lower-density extractant (mixture) is selected.
The diameter of the dome can be selected to be larger.
A coarse filter can be attached at a transition between the working space and the dome. Said filter can be cleaned by the shaft structures, in that said attachments convey particles, located on the filter on the working space side, away in the direction of the first discharge device.
If the mixing kneader comprises a plurality of first input devices, then a first input device that is furthest from the dome can be selected for inputting the extraction material.
The extraction material can be input via a first input device, which is arranged downstream of at least one sealing disc, serving as a screw fitting, with respect to the conveying direction of the extraction material. The above-mentioned sealing disc which is located upstream in the conveying direction, with respect to said first input device, can serve as a closure if it is configured correspondingly such that it forms a barrier with respect to the particles, but not with respect to the extractant.

As is in particular also described below with reference to the method according to the invention, the mixing kneader is preferably completely filled with the mixture to be processed.

The working space is thus completely filled during operation. If a dome is present and the second discharge device is arranged therein, then during operation the dome is preferably also filled at least in part. Preferably, the dome is filled at least to such an extent that the inlet opening of the second discharge device is located within the dome, under the surface (for example liquid level), present there, of the mixture to be processed.

If a filling level or flooding level with respect to the mixing kneader is defined, then said level—depending on the design of the mixing kneader—is located at least at the same level as the maximum height of the working space. If a dome, comprising an inlet opening located therein for the discharge of the extract solution into the second discharge device, is provided, then the filling level or flooding level is located even above the maximum height of the working space, specifically at least at the height at which the inlet opening for the discharge of the extract solution into the second discharge device is arranged.

Unless otherwise specified, the above-mentioned dome is always arranged above the working space.

The above-mentioned conveying direction of the extraction material, and the flow direction of the extractant, described below, are to be understood as effective movement directions of the mentioned substances and components in the longitudinal direction of the mixing kneader, i.e. in the axial direction with respect to the axis/axes of the shaft(s). Of course, the mentioned movements are only resulting movements. Finally, the rotational movement of the shafts, and the resulting conveying movement, as well as gravity, exert and transmit various impulses and forces to each particle and each volume element in the working space of the mixing kneader, for example by the forced flow of the extractant in the flow direction. In addition, viscosity, friction and shear stresses, etc. are to be taken into account, which all have an effect on the ultimately resulting movement of each volume element and each particle.

A person skilled in the art, however, does not need to know these phenomena, underlying the resulting movement, in detail. A person skilled in the art does not even have to know the movement states of the particles and volume elements acting in each case in the axial and radial direction (with respect to the longitudinal axis of the shaft(s)). Rather, in order to achieve the effect of the present invention, it is sufficient to achieve the effective, i.e. the resulting, movement. Suitable tests can be carried out for this.

For example, when the mixing kneader is brought into operation, the volume flow of the extract solution after the second discharge device, and the mass flow of the extraction residue after the first discharge device, can be identified and kept as constant as possible. In order to achieve this, a person skilled in the art can for example set the rotational speed of the shaft(s), a feed rate of the extraction material, a feed rate of the extractant, and the temperature in the working space, in a corresponding manner.

If, alternatively or in addition, an extraction that is complete as possible is to be achieved, then samples of the extraction residue and/or the extract solution can be taken. Then, a remaining proportion of the components to be removed in the extraction residue and/or a proportion of the component to be removed in the extract solution can be determined. After one of the above-mentioned parameters has changed it is possible to check, by renewed sampling, whether a more effective extraction has been achieved, i.e. whether the proportion of the component to be removed, in the extract solution and/or in the extraction residue, has been reduced.

The first discharge device can comprise means for conveying the extraction material and the extraction residue. In this case, it should be noted that the extraction material transitions, during the extraction, i.e. while passing through the mixing kneader, into the extraction residue, i.e. is converted into the extraction residue by release of the at least one component. The conveying means can in most cases convey both the extraction material and the extraction residue, since the substance that later remains as extraction residue, which is an essential component of the extraction material, preferably does not, or at least does not significantly, dissolve in the extractant. Of course, a mode of operation is particularly preferred in which largely or exclusively the extraction residue is present at the first discharge device, because the component to be extracted, i.e. the extractive, has been completely removed. In each case, at least a significant part of the component to be extracted is removed from the extraction material.

Furthermore, at least one portion of the first discharge device can be arranged higher than the working space of the mixing kneader, wherein the first discharge device can be configured to separate remaining extractant from the extraction residue by the effect of gravity.

The first discharge device can comprise a dispensing point, at which it dispenses the extraction residue removed from the working space or transfers this to a downstream facility. In particular, said dispensing point is preferably arranged higher than the highest point of the working space.

For example twin discharge screws, extruders, screws and rotary valves are possible as conveying means.

The first discharge device can be configured to separate the extraction residue, which can be present in the extractant for example in the form of solid particles or drops of a highly viscous liquid, from the extractant by the action of gravity, if extractant penetrates into the first discharge device. In this case, the separation can take place for example according to the principles of sieving, decanting, classification or squeezing out. Preferably, however, mechanical separation takes place in at least one discharge screw, which can operate according to the principle of a screw.

The bars of the mixing kneader, which, in ongoing operation, i.e. when the shaft or the shafts rotate(s), pass bars of the second shaft or counter hook, can be at a minimum spacing of 1 to 30 millimetres from one another or from the counter hook. This serves for the following comminution of the extraction material into particles, which is described in more detail in particular with respect to the metho according to the invention. Preferably, the minimum spacing is between 1 and 20 millimetres, more preferably between 1 and 15 millimetres.

In general, it is preferred for kneading elements, which pass one another during ongoing operation, are at a minimum spacing from one another of 1 to 30 millimetres.

During the communition, the extraction material is broken down mechanically into particles or clumps, which can take place by chopping, cutting, shredding or the like. This comminution results in a very efficient extraction because a surface of the extraction material that is accessible for the extractant is increased. Since the working space of the mixing kneader is completely filled with the mixture to be processed, the surface newly resulting from comminution also comes into direct contact with the extractant, which is also advantageous.

The complete filling of the mixing kneader working space causes an extraction material, which has the undesired property of adhering very strongly to the inner surfaces of the mixing kneader to also be removed very efficiently from said surfaces. The inventors have observed that this self-cleaning, which is known per se, does not occur to a sufficient extent in the case of only partially filled mixing kneaders, when the extraction material is very tacky. In this case, the tackiness of the extraction material, i.e. its tendency to adhere to the inner surfaces of the mixing kneader, of course depends on the selection of the extractant and also on the quality of the inner surfaces of the mixing kneader, and can be very easily determined experimentally by observation.

Based on the “underwater pelletization”, which is known in the polymer industry, the comminution could also be referred to as “pelletization below the liquid surface”, wherein this step preferably differs from a known underwater pelletization inter alia in that the liquid does not serve primarily for cooling and exclusion of oxygen, and the particles, unlike “pellets”, are typically not solid or quasi solid.

By selecting the above-described spacing, the particles of the extraction material are cut or comminuted to a preferred size. As soon as the shaft or the shafts rotate, as is known a meshing movement of the bars of the shafts or both shafts takes place, during which in each case bars or elements of the counter hooks similar to the bars pass one another, i.e. move past one another, wherein the come very close to one another. In the case of twin-shaft mixing kneaders, bars of both shafts pass one another with the above-mentioned spacing, in the case of single-shaft mixing kneaders the bars of the shaft approach the bars or the like of the stationary mating elements or counter hooks, up to the above-mentioned spacing.

In this case, the above-mentioned minimum spacing is the smallest spacing that is achieved during this movement. The minimum spacing during this movement, i.e. the minimum gap between two bars or between bars and counter hooks, is intended to be between 1 and 30 millimetres, depending on a desired particle target size. Bars and counter hooks are kneading elements. Thus, the minimum spacing between the kneading elements present in the mixing kneader should be between 1 and 30 millimetres. The particle target size is understood to mean the desired average size of the particles which is intended to be present immediately before the particles are discharged. Preferably, this spacing between the kneading elements can be between 1 and 20 millimetres, more preferably between 1 and 20 millimetres, more preferably between 1 and 15 millimetres, even more preferably between 1 and 10 millimetres, or between 1 and 8 millimetres. Spacings of from 2 to 10 millimetres, of from 4 to 10 millimetres, and of from 5 to 10 millimetres, and of from 6 to 8 millimetres are more preferred. Suitable spacings, at which the particle target size is achieved, can also be determined empirically by tests.

The at least one shaft of the mixing kneader is preferably configured to achieve a conveying direction of the extraction material and of the extraction residue from the first input device to the first discharge device, even though a flow direction of the extractant runs opposingly. This can be achieved for example by a suitable selection of the bar shape and setting of the conveying angles of the bars.

The conveying angles of the bars can be between 5° and 45°. In this case, a conveying angle is understood to mean the angle between the bar longitudinal axis and the shaft axis. The conveying angles can preferably be between 9° and 40°, between 15 and 35°, between 20° and 35°, between 25 and 35° or between 28° and 33°. Conveying angles of between 6° and 30° are also conceivable. The conveying angles can also be determined and optimised empirically or experimentally in the tests.

The bars can also be equipped with what are known as wings on their longitudinal ends. Wings refers to cleaning elements on the ends of the bars, oriented radially against the shaft core, which elements serve for cleaning the discs and which can be configured uniformly with the discs or as mixed L-shaped, T-shaped and U-shaped. L-shaped means a bar having a wing only on one side, U-shaped means a bar having wings on both sides, and T-shaped means a bar without wings. Uniform means that only L-shaped, T-shaped or U-shaped discs with bars are present. Mixed means that a combination of L-shaped, T-shaped or U-shaped discs with bars is present.

The first input device can be arranged within the input side downstream of the second discharge device with respect to the conveying direction of the extraction material, such that the extraction material is transported away from the second discharge device immediately after being fed into the working space, in the conveying direction. This can reduce the risk of a portion of the extraction material reaching the second discharge direction and for example clogging the filter there or even penetrating into the dome and subsequently into the inlet opening in the second discharge device, immediately after it has been introduced into the working space.

In particular, the arrangement of the input and discharge devices and/or the conveying angles of the bars can bring about counterflow transport within the mixing kneader. By means of the counterflow principle, the extraction material is mainly surrounded by the extractant, directly before leaving the working space through the first discharge device, which ensures that the discharged extraction residue is largely or at least as far as possible free of the at least one component to be dissolved (extractive). Typically, the adjustment of the conveying angles of the bars achieves transportation of the extraction material to be processed, within the working space, counter to the flow direction of the extractant.

A flow direction of the extractant is preferably counter to the conveying direction of the extraction material. A volume flow of the extractant in its flow direction can be produced in that it is introduced into the working space in a suitable manner, via the second input device. In this case, pumps and the like are conceivable. The second input device is preferably arranged upstream of the first discharge device, within the discharge side, wherein “upstream” refers to the flow direction of the extractant. Since the mixing kneader is operated in the counterflow method, and thus the extractant and the extraction material move opposingly, “upstream” with respect to the flow direction of the extractant corresponds to a “downstream” movement with respect to the conveying direction of the extraction material.

With regard to the flow direction and the conveying direction, it is mentioned that these are axially extending effective movement directions, i.e. the observable movement of for example introduced extraction material from the first input device to the first discharge device. Of course, in the mixing kneaders used the movement direction of a specifically observed particle or volume element will not extend straight and in parallel with the shaft axis. Instead, its path will be influenced by the movement of the shafts, also by radial movement components (with respect to the shaft axes). The (axial) conveying or flow direction thus refers to the axial vector or an axial component of the conveying or flow direction vector. A particle, mentally “marked” for sampling purposes, or a corresponding volume element of the extractant, enters the mixing kneader via the respective input device, and leaves said mixing kneader again via the respective discharge device. The particle or the volume element has thus effectively overcome an axial distance, even if the path from the input to the discharge device was not the shortest. The particle or the volume element has nonetheless effectively moved axially.

The mixing kneader can comprise a dome, in which the second discharge device is located. Domes of this kind are known and have already been described above. These are substantially chimney-like openings above the shafts.

The advantage of a dome of this kind is that a calm liquid surface forms in the interior thereof, such that no suction occurs, which attracts particles of the extraction material, located in the vicinity, in an undesired manner, and then possibly discharges these directly out of the mixing kneader again, via the second discharge device. The dome thus provides a calming zone. This applies irrespective of whether the dome is arranged above or below the working space.

Preferably, the inlet opening of the second discharge device is located approximately centrally with respect to a cross section of the dome, where it is calmest. It is also conceivable to deter the particles from flowing into the inlet opening of the second discharge device by means of an automatically occurring rotating dome current (eddy). As a variant, the eddy can also be conveyed or forced by means of a separate actuator, such that smaller particles and what are known as fines can also be better separated, similarly to centrifugal separation or cyclone separation.

In this connection, a device for mechanical separation provided by the embodiment of the dome has already been described above. With reference to the figures, further devices are described in the following, which can prevent an undesired penetration of particles into the inlet opening of the second discharge device located in the dome.

The dome is preferably dimensioned to be large in relation to the mixing kneader. If the working space of the mixing kneader is for example approximately 4.5 metres long, then the dome can be approximately 30 to 120 centimetres (cm) high and have a diameter of approximately 30 to 120 cm. In general, the height and diameter of the dome can preferably in each case be approximately 5 to 25%, preferably 10 to 15%, of the length of the working space. The height and diameter of the dome do not have to be identical. For example, the height can be 8% and the diameter 13% of the length of the working space.

The numbers specified above relate to the example of an approximately 4.5 metre long mixing kneader, and can deviate in the case of longer and shorter mixing kneaders.

The first discharge device can comprise two discharge members, for example discharge screws, connected one behind the other.

At least one of the discharge members, in particular discharge screws, can be heatable. In this way, any extractant still present can already be removed from the extraction residue in the discharge member, by the action of heat.

In addition to the mixing kneader comprising the above-described components, the present invention also includes the extraction method described below. Method steps which have already been described above with respect to the mixing kneader can of course be transferred to the method described below, and vice versa.

Furthermore, the present invention also includes the use of a mixing kneader described above for carrying out a continuous extraction.

The method according to the invention for the continuous extraction of at least one component from an extraction material in a mixing kneader according to the invention comprises the following steps:
feeding the extraction material into the mixing kneader via at least one first input device,
feeding the extractant into the mixing kneader via the second input device,
wherein the working space is filled completely with the mixture to be processed, comprising the extraction material and the extractant,
wherein the extraction material or the extraction residue is conveyed effectively, with respect to an imaginary longitudinal direction of the at least one shaft, by the movement of the at least one shaft, from the first input device to the first discharge device, and is discharged from the first discharge device,
wherein the extraction material preferably overcomes a counterflow of the extractant when passing through the mixing kneader,
wherein the extractant flows from the second input device to the second discharge device, overcoming a conveying movement caused by the movement of the at least one shaft, and
wherein the extractant is selected in such a way that it dissolves or emulsifies or suspends or chemically modifies the at least one component to be dissolved from the extraction material, under the process conditions prevailing in the mixing kneader, and wherein
the extractant is furthermore selected such that it does not dissolve or emulsify the component of the extraction material remaining as extraction residue, optionally after addition of a precipitant and/or a flocculant, under all conditions of extraction material and extractant occurring in the mixing kneader, and wherein
the component of the extraction material remaining as extraction residue is selected such that it is present as a solid or as a highly viscous liquid, optionally after addition of a precipitant and/or a flocculant, under all conditions of extraction material and extractant occurring in the mixing kneader.

The above-mentioned conveying movement means, for example, the forced movement of a particle to which an impulse is transmitted when it strikes the rotating shaft structures. In the context of the present invention, this impulse is preferably directed substantially in the conveying direction and ultimately ensures that the particles move in the conveying direction.

The extractant can furthermore be selected such that it does not suspend the component of the extraction material that remains as extraction residue. For example, the extractant can ensure the formation of larger particles of the extraction residue, which, on account of their size, are not to be considered particles of a suspension, because they are for example more than 1 millimetre large.

The extractant can be selected such that it does not chemically modify the component of the extraction material that remains as extraction residue.

The component of the extraction material that remains as extraction residue is furthermore preferably selected such that it is always present in the form of particles, even in the case of a comminution by the shaft structures, described in more detail in the following, which particles are conveyed to the first discharge device by the movement of the at least one shaft.

In general, the extractive is present as a solution in the extractant. In rare cases, however, it is conceivable that both the extractive and the extraction residue are present as suspended particles in the extractant. In this case, however, the extractive particles are preferably so small that they flow with the extractant to the second discharge device. In contrast, the particles of the extraction residue are preferably so large that they are conveyed by the shaft structures to the first discharge device.

If the component to be dissolved does not dissolve in the extractant, but rather is present as a suspension, then the suspended particles of the extractive are usually smaller, preferably significantly smaller than 1 millimetre. In contrast, the particles of the extraction residue are in any case at least 1 millimetre in size and are therefore outside the particle sizes typical for suspensions. The extractive can thus be present as a suspension, wherein the extraction residue is present as a mixture of larger particles in the extractant. Preferably, the component of the extraction material remaining as the extraction residue is thus not suspended in the conventional sense, since it is present in the form of particles which are at least 1 mm in size and are therefore outside of the range typical for suspensions.

The extraction material consists in (usually large) part of the substance that later remains as the extraction residue, which substance, usually under the process conditions prevailing in the mixing kneader, is preferably insoluble in the extractant. For this reason, the extraction material can be comminuted into particles and conveyed by the movement of the shafts, which will be explained in greater detail in the following.

Preferably, the mixing kneader is firstly completely filled (“flooded”) with the extractant, before the continuous extraction is started by introducing the extraction material.

Preferably, both the extraction material and the extraction residue that remains after the extractive has been dissolved are present as a solid or a highly viscous liquid. Within the context of the present invention, the term “highly viscous” is understood functionally. In the context of the present invention, a fluid extraction material is to be considered highly viscous if it can be moved effectively in the conveying direction. A highly viscous fluid extraction material thus moves effectively counter to the flow direction of the extractant, instead of being carried along therewith.

Whether a highly viscous fluid extraction material moves in the conveying direction can depend on all the process conditions (see below).

In the context of the present invention, “highly viscous” is thus not an absolute substance property of the fluid extraction material. Instead, “highly viscous” denotes the empirically determinable property of the extraction material to move effectively in the conveying direction under the given process conditions.

Typically, but in a non-limiting manner, those liquids having a viscosity of over 500 Pa*s, based on a shear rate of 100*S\hat{ }−1, are possible as highly viscous liquids.

In the context of the present application, these process conditions include inter alia the temperature, the pressure, the shear rate, the selection of extraction material and extractant, and the rotational speed of the at least one shaft.

The method according to the invention also includes variants in which although the substance that remains later, i.e. after the extraction has been carried out, as the extraction residue is soluble in the extractant under certain conditions, at least in part, the process according to the invention is carried out in such a way that said substance precipitates, for example by addition of a precipitant, and consequently is not transferred as a dissolved component into the extractant. Thus, the substance remaining as the extraction residue is not discharged through the second discharge device. It is thus specifically conceivable to add the extraction material via the first input device, and furthermore to feed a precipitant into the mixing kneader, in order to ensure that the substance that remains later as the extraction residue does not dissolve in the extractant. In this way, it is ensured that, after being fed into the mixing kneader, the extraction material can for example be comminuted into particles and conveyed by the movement of the shaft. If both the component to be dissolved (extractive) and the substance later remaining as the extraction residue were to dissolve in the extractant, then the extraction material would dissolve completely or at least substantially, and the method according to the invention could not be performed.

If the extractive is present, after introduction into the mixing kneader, as a finely distributed suspension or emulsion, in particular colloidally, then a flocculant can be added. A flocculant of this kind causes formation of larger flocks from smaller colloidally distributed particles or drops.

The flocculant can cause the agglomeration of particles and the formation of agglomerates.

If, optionally after addition of a flocculant, smaller flocks or particles are present in the extractant, which flocks or particles are not conveyed in the conveying direction by the movement of the shaft(s), then addition of a flocculating aid is conceivable. A flocculating aid of this kind causes formation of larger flocks from smaller colloidally distributed particles or drops.

The mixture to be processed is understood to be all substances which are located in the working space. These include the extraction material and the extractant, but also the components thereof, i.e. in particular also the extractive. In this case, it is irrelevant whether and in what form the substances and components combine in the mixture, and what type(s) of mixture(s) they form. These substances and components are always referred to, in summary, as the “mixture to be processed”. Even when the extractive leaves the extraction material and dissolves in the extractant, which is then referred to as the extract solution, all the mentioned components and substances are still covered by the term “mixture”. This also applies for any reaction products of the mentioned substances and components, if a chemical reaction takes place during the extraction.

The extractant should be selected, with respect to its viscosity, in such away that it continues to flow in the flow direction, i.e. counter to the conveying direction, despite the movement of the shafts and the conveying effect, generated thereby, in the conveying direction. The movement of the shafts usually counteracts, to some degree, a movement of the extractant in the flow direction, i.e. the flow movement in the flow direction is usually braked, at least slightly. However, the extractant is preferably selected such that its effective movement takes place in the flow direction, i.e. towards the second discharge device, and not in the opposingly extending conveying direction.

Most conventional extractants have a sufficiently low viscosity and therefore fulfil this condition. This applies in particular for methanol, ethanol, isopropanol, dichloromethane, chloroform, diethyl ether, and the like. This also applies for extractants having slightly higher viscosity, for example water.

Emulsification of the component to be dissolved, in the extractant, can take place with the aid of an emulsifier or purely physically, for example by the movement of the at least one shaft. After the emulsification, the component to be dissolved is preferably present finely distributed in the extractant. Owing to the fine distribution, the component to be dissolved is therefore no longer conveyed with the remaining extraction material in the direction towards the first discharge device, but rather flows with the extractant to the second discharge device.

Analogously to the emulsification described above, suspension can take place purely physically or with the addition of auxiliary agents.

A substance can be added to the extractant, which substance acts as a binder with respect to the substance that forms the extraction residue, and thus also with respect to the extraction material immediately after the infeed into the mixing kneader. The binder can be used in addition or alternatively to the precipitant and flocculant also mentioned. The binder can for example be a solid or a liquid. The binder preferably causes substance that forms the extraction residue to be present bound to the binder in particle form, in order to be conveyed by the shaft structures to the first discharge device. Furthermore, the binder is preferably selected such that it does not bind the component to be dissolved (extractive). The extractive should also be dissolved from the extraction material, in the course of the counterflow extraction according to the invention, even if the substance which later remains as the extraction residue is bound to the binder.

The extraction material or the extraction residue can for example be adsorbed at the binder.

The addition of an above-described precipitant and/or an above-described flocculant and/or an above-described flocculating aid and/or an above-described binder can take place at various points along the longitudinal axis of the mixing kneader. The above-mentioned agents can furthermore be added at a single point or at a plurality of points distributed along the longitudinal axis.

The extraction material is preferably comminuted by the shaft structures, by the movement of the at least one shaft. In this case, the spacings between the bars can be adjusted such as has already been described with respect to the mixing kneader according to the invention. Furthermore, the speed of rotation of the shaft or the speeds of rotation of the shafts can also be adjusted. An optimum speed of rotation of the at least one shaft can also be determined experimentally. From experience, the speed of rotation can be for example between 10 and 50 rpm, in order to ensure that the particles of the extraction material and of the extraction residue are comminuted to a sufficient extent and conveyed as desired in the conveying direction. At the same time, the mixture located in the working space should be sufficiently mixed in order to release the extractive as far as possible completely from the extraction material.

Preferably, the length of the shaft(s) substantially corresponds to the length of the mixing kneader, i.e. the shaft(s) pass(es) through the entire working space. Preferably the shaft structures, already described, also occupy the at least one shaft over its entire length, such that the above-described mixing and comminution can take place over the entire length of the working space. At least the shaft structures are in any case present between the first and the second input device, such that at most the two ends of the shaft(s) cannot be occupied with shaft structures.

The speed of rotation is preferably selected experimentally with respect to the combination, to be processed in each case, of extraction material and extractant, and possibly taking into account the process conditions, in such a way that the desired comminution of the extraction material to particles takes place to such an extent that said particles can still be conveyed by the shaft structures counter to the flow direction of the extractant. Particles that are too small, in particular what are known as “fines”, can be so small that they cannot be conveyed in the conveying direction but rather flow in the flow direction. The size from which particles are “too small” depends once again on the process conditions and can be determined empirically in that the size from which fines leave the mixing kneader through the second discharge device, together with the extract solution, is determined.

Furthermore, the extraction material, extractant and process conditions are preferably selected such that the resulting particles are held in suspense instead of sinking or rising, following gravity or their buoyancy. In order to keep particles held in suspense, typically in particular a suitable selection of the speed of rotation of the shaft(s) will be decisive.

The extraction material preferably has the same density as or a higher density than the extractant. In this case, a mixing kneader having a dome attached at the top is preferably used. This results in the advantage that the extraction material does not float, which would hinder mixing into the solvent by the shafts. In the context of the present invention, floating is understood to mean particles rising on account of a lower density compared with the liquid surrounding them.

The shaft of a mixing kneader, as the inventors have found by experiments, can swirl up sinking extraction material particles without problem, in order to distribute said particles in the working space of the mixing kneader. Here, promoted by the movement of the shafts, the extraction finally also takes place, as well as the comminution, already described, of the extraction material and the conveying thereof in the direction of the first discharge device.

However, it is also conceivable for the density of the extraction material to be lower than the density of the extractant. In contrast to the other embodiments described in the present application, in this case preferably a mixing kneader is used which comprises a dome that is attached to the working space at the bottom and points downwards. A siphon can be envisaged here, in order to keep the desired filling level, wherein other devices for controlling or regulating the filling level can also be envisaged. For example pressure gauges can be envisaged, which indirectly determine a level of a liquid column and make it possible to infer the filling level. Furthermore, floats or the like can also be envisaged.

In most embodiments of the present invention the dome (which is optionally but preferably provided) is arranged at the top, i.e. above the working space. The particles of the extraction material generally have a higher density than the extractant, and consequently sink. The dome and thus also the second discharge device arranged in the dome are arranged above the working space. This already prevents, to a certain extent, the particles from entering the second discharge device, because, without a movement forced from the outside, as mentioned above, they tend to sink.

If an extraction material is treated in the mixing kneader, the particles of which float due to their low density, then the dome is expediently arranged under the working space. In said dome arranged under the working space, the second discharge device can then be arranged at the greatest possible radial spacing from the longitudinal axis of the mixing kneader. As a result, undesired penetration of the floating particles into the second discharge device is prevented.

If the dome is arranged under the working space, then it can be connected to a siphon, the highest point of which is located above the working space. This serves for setting the filling level and can in particular ensure that the working space is always completely filled. The combination of the dome and siphon is in particular described in greater detail with reference to the figures.

The method according to the invention preferably has a mechanical separation between the extract solution and extraction material, in order to prevent untreated extraction material from being removed from the reaction space again, immediately after entering the reaction space, via the second discharge device. Preferably the device for mechanical separation already described with respect to the mixing kneader according to the invention is used for this purpose. Furthermore, the sealing discs, also described with respect to the mixing kneader, on the shaft or on the shafts can be envisaged.

The extraction method according to the invention can be a chemical or a physical extraction method. The component to be extracted can thus be chemically modified (chemical extraction), or only dissolved and adsorbed (physical extraction). It can also be envisaged that the component to be extracted is emulsified or suspended in the extractant, which, in the context of the present invention, is also considered to be physical extraction. Preferably physical extraction takes place within the context of the present invention.

In the context of the present invention, a plurality of different types and classes of extraction materials can be treated. In general, the extraction material is a solid or a highly viscous liquid, while the extractant is usually a low-viscosity liquid such as ethanol.

The present invention is for example suitable for removing water from a mixture containing a superabsorbent polymer (SAP). SAP is often present, immediately after the polymerisation, as what is known as a polymerizate, and still contains water which, up to now, had to be removed by means of laborious and energy-intensive drying. Thus, in this case, water is the component to be extracted, and the SAP polymerizate is the extraction material. Thus, in this case, the extraction material to be processed is “SAP (polymerizate)+water”; water is the extractive. In particular when the polymerizate is thick, a mixing kneader according to the invention is well suited for extraction of the water from said polymerizate.

The SAP can be formed of known crosslinked polymers, wherein these polymers are generally polar. For example, polyacrylamide, polyvinylpyrrolidone, amylopectin, gelatine cellulose, or a copolymer of acrylic acid and/or (sodium) acrylate with acrylamide are possible. If the SAP is based on the last-mentioned copolymers, then crosslinking agents are often added, wherein core and/or surface crosslinking agents can be used. The structure and preparation of such SAP is known from the prior art, for example from the book “Modem Superabsorbent Polymer Technology” by F. L. Buchholz and A. T. Graham (John Wiley & Sons, 1998, ISBN 0-471-19411-5), where further SAP forms and types are also described in chapter 6, and SAP applications are described in chapter 7.

The present invention is of particular significance for the preparation of superabsorbent polymers (SAP) for hygiene products based on renewable raw materials, in particular crosslinked polysaccharides, in particular carboxymethylcellulose (CMC) or hydroxymethyl cellulose (HEC), as described for example in EP0994734B1. According to EP0994734B1, polar solvents, in particular ethanol, acetone or isopropanol, can be used for extraction of water. The particular significance of the method according to EP0994734B1 is in the significantly higher absorption rates which are achieved by means of extraction, compared with air or vacuum drying. EP0994734B1 describes twice-repeated extraction, i.e. a batch process.

According to one embodiment of the present invention, the method described in EP0994734B1 is carried out continuously, which implies a commercial advantage in the case of industrial implementation. In this case, for example ethanol is used as the extractant, in order to simultaneously continuously remove the water from the SAP polymerizate, and in the process replace the water physically bound in the SAP, while the water builds up continuously in the ethanol. Thus, in addition to the extraction—the release of the water—a replacement of the component to be extracted also takes place, because ethanol in the pores and spaces of the SAP prevents their collapse and sticking together during drying, which leads to a porous, absorption-increasing structure of the polymer. At the same time, the extracted water builds up in the ethanol that is freely flowing (i.e. not penetrated into the pores of the SAP). The fraction of water in the ethanol increases in the flow direction (of the ethanol). As already described, said ethanol/water mixture can then be referred to as the extract solution.

All details regarding the flow direction, etc., which have been given with respect to the extractant, of course also apply for the extract solution. The same of course also applies for the extraction material with respect to the extraction residue.

In addition to extractions in which exclusively release of at least one component from the reaction material takes place, the present invention also includes methods in which a replacement and/or exchange as described above takes place. In this case, however, the present invention is not restricted to methods for processing the substances named specifically and by way of example (SAP, water, ethanol). The essential concept of replacing the component to be extracted with the extractant, at the same time as the extraction according to the invention, can thus of course also be transferred to other applications, and is not restricted to ethanol and not to SAP.

In addition to the mentioned quality advantage (higher absorption rates), an advantage of the specific example comprising the exchange of water in the SAP polymerizate for ethanol is that the ethanol can be removed from the SAP significantly more easily and using less energy.

In this case, it is always advantageous if the extractant has a lower enthalpy of evaporation and/or a lower evaporation temperature than the component to be dissolved.

Following the above-described extraction with simultaneous replacement of the extracted component, drying of the remaining extraction residue can take place, which proceeds in an energy-efficient manner and gets by with less heat input due to the above-mentioned exchange and owing to the low enthalpy of evaporation and/or evaporation temperature of the extractant. In this case, any known drying methods are conceivable.

In addition to the extraction of for example water from SAP polymerizates, the present invention is also suitable for removing sulphur and sulphur compounds from rich oil. Thus, in this case, the extraction material to be processed is “rich oil+sulphur compound(s)”. Sulphur and sulphur compounds are often referred to as sulphur compounds. This is in general “conventional” extraction, in which the extractant does not build up in the rich oil as a replacement of the sulphur compounds.

A further application relates to the extraction of catalysts after polymerisation, such as the extraction of a Ziegler-Natta catalyst. A method for removing solvent from a polymer solution following polymerisation, which corresponds to the prior art, is what is known as the steam stripping method, in which typically a chloride ion-containing catalyst, for example TiCl-4, reacts, during intensive contact with steam and water current, serving primarily to remove the solvent, in that the TiCl4, by way of example, reacts with water to form TiO2 and HCl, as a result of which the catalytic compound abreacts and is no longer available for physical recycling. The hydrogen chloride compound, by way of example HCl, leads to an increased tendency to corrosion. The use of the device according to the invention makes it possible for the catalysts, for example TiCl-4, to be extracted from a polymer solution, for example with ethanol, subsequently supplied to physical recycling, and supplied, without a tendency to corrosion, to a direct degassing method, as described for example in U.S. Pat. No. 8,519,093B2, which prevents the high energy expenditure and high water use.

This can also take place using ethanol or other short-chain alcohols as the extractant, since thiols, sulphides and sulphur-aromatic compounds usually dissolve well in methanol, ethanol or propanol. Other hydrocarbons and hydrocarbon compounds are also possible as alternative extractants, for example short-chain aliphatic hydrocarbons such as hexane, heptane, etc. This process is very resource-efficient because the rich oil can be treated at temperatures of between 20° C. and 100° C. and normal pressure. In the prior art, often very high temperatures and very low pressures are required for removing the above-mentioned sulphur-containing components. In this case, the temperature is expediently also selected in view of the extractant, sine it should usually remain below its boiling point. If methanol is used as the extractant, the temperature should thus be below 65° C., in the case of ethanol below 78° C., in the case of iso-propanol below 82° C., and in the case of propanol below 97° C. Furthermore, rich oil is highly viscous to such an extent that, similarly to the polymer SAP, it is insoluble in the extractant ethanol, and can be cut and conveyed along the mixing kneader, to the first discharge device, by the movement of the shafts and the conveying effect of the bars. Furthermore, rich oil has a higher density than ethanol.

Instead of ethanol, as already indicated, depending on the extraction material for example also alkanes, aromatic compounds, alcohols, kerosene, or mixtures of the above-mentioned substances, are used as the extractant.

In addition to SAP, of course a very wide range of other polymers or polymerizates are possible. In this case, it is also irrelevant whether the extractant simultaneously also penetrates into the polymer(izate) as a replacement for the water which was previously present.

Instead of the rich oil, of course other highly viscous liquids can also be treated using the method described above, as long as said liquids can be conveyed in the conveying direction. Preferably, such highly viscous liquids are also, like rich oil, comminuted by the bars. In particular, a plurality of highly viscous residues from crude and raw oil processing (“column sump”) are conceivable.

### BRIEF DESCRIPTION OF THE DRAWINGS

Further advantages, features and details of the invention emerge from the following description of preferred embodiments, and on the basis of the drawings, in which:

FIG. 1 to 3 show an embodiment of a twin-shaft mixing kneader 1 according to the present invention,

FIG. 4 shows an embodiment of a single-shaft mixing kneader 1 according to the present invention,

FIG. 5 shows an embodiment of a further mixing kneader 1 according to the present invention,

FIG. 6 shows an alternative embodiment of a mixing kneader 1 according to the present invention,

FIGS. 7 and 8 show two embodiments of devices for mechanical separation,

FIG. 9 shows a screw 26, and

FIG. 10 shows a further mixing kneader 1 according to the present invention.

### DETAILED DESCRIPTION

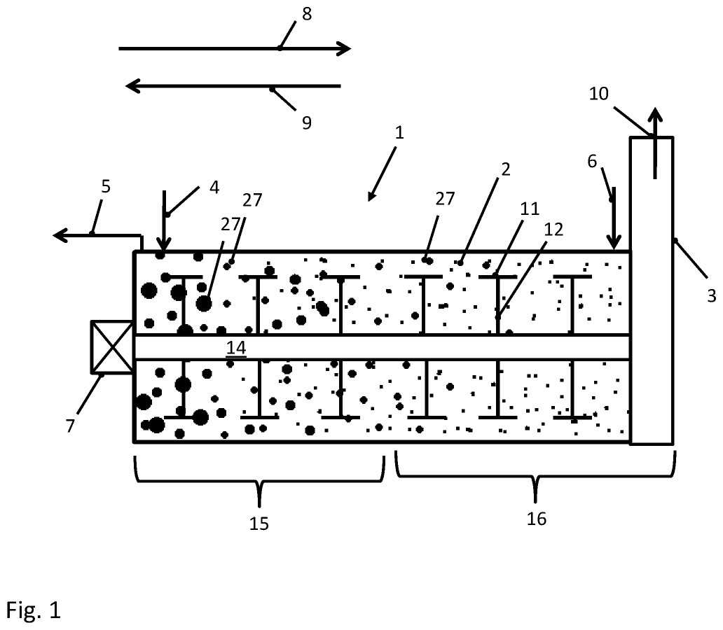

FIG. 1 is a partially cut away side view of a mixing kneader 1. The mixing kneader 1 comprises a working space 2, in which two shafts 14 having shaft structures in the form of discs 12 and bars 11 extend, wherein just one shaft 14 is visible. The shaft 14 is driven by a drive 7. Two input devices 4, 6 and a second discharge device 5 are merely indicated by arrows. Furthermore, a first discharge device 3 is shown, the dispensing point 10 of which is arranged higher than the working space 2.

By means of the mixing kneader 1, for example an aqueous polymerizate of a superabsorbent polymer (SAP) can be treated, wherein said polymerizate represents the extraction material.

A conveying direction of the polymerizate is indicated by an arrow 8.

A flow direction of an extractant, e.g. ethanol, is indicated by an arrow 9.

Furthermore, an input side 15 and a discharge side 16 of the mixing kneader 1 are indicated.

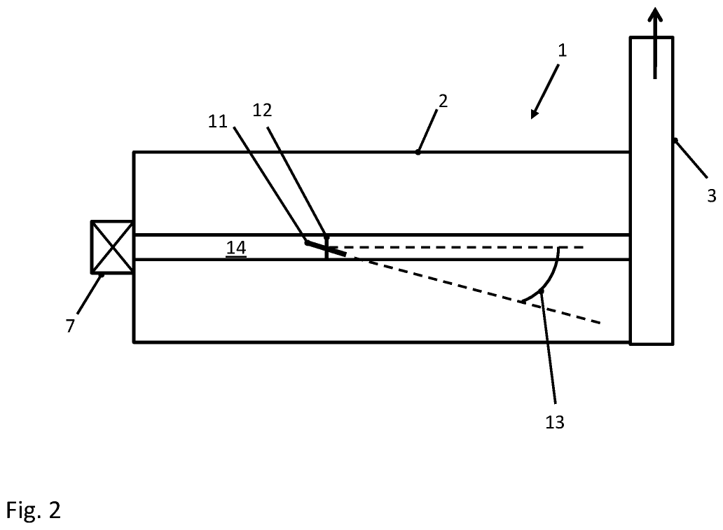

FIG. 2 shows the mixing kneader 1 according to FIG. 1 in a highly simplified form, and a large number of details have been omitted. FIG. 2 shows a conveying angle 13, identifiable as the angle between a longitudinal axis of the shaft 14, shown in dashed lines, and a longitudinal axis of a bar 11, also shown in dashed lines.

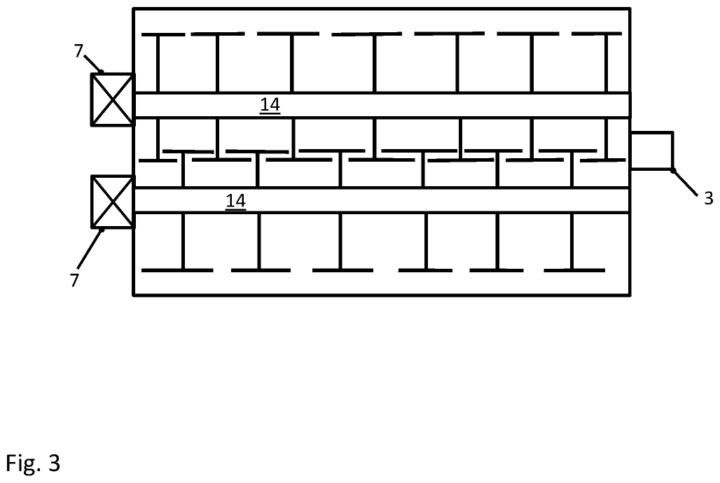

FIG. 3 is a plan view of the mixing kneader 1 according to FIGS. 1 and 2.

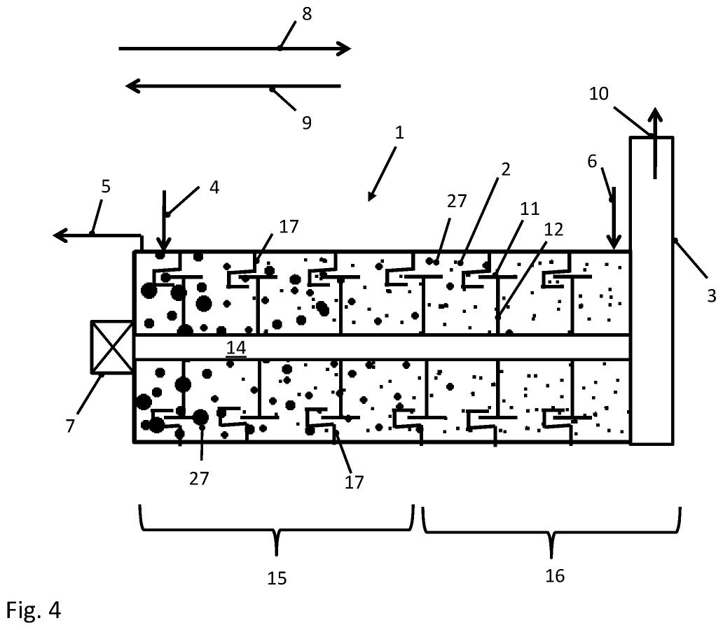

FIG. 4 shows a single-shaft mixing kneader 1, in a view analogous to FIG. 1. The single-shaft mixing kneader 1 according to FIG. 4 differs from the twin-shaft mixing kneader 1 according to FIG. 1 to 3 essentially by the stationary kneading counter hooks 17 which are attached to the inside wall of the housing.

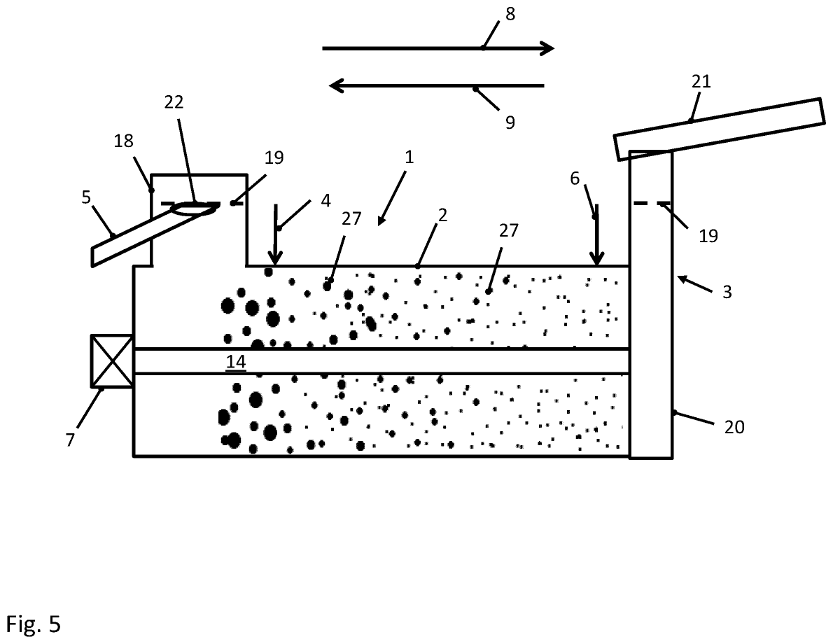

FIG. 5 shows a mixing kneader 1 comprising a dome 18 and a first discharge device 3 comprising two screws 20, 21. The first input device 4 is arranged downstream of the dome 18 in the conveying direction 8. Furthermore, a filling level 19 is sketched in.

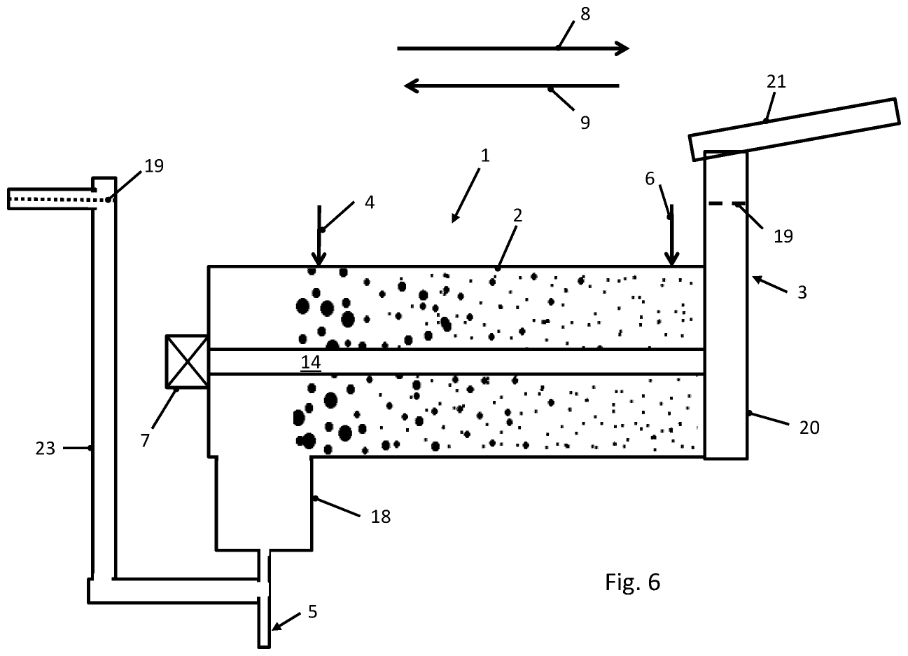

The mixing kneader 1 according to FIG. 6 differs from that according to FIG. 5 by the downwardly facing dome 18 and the siphon 23 connected to the second discharge device 5.

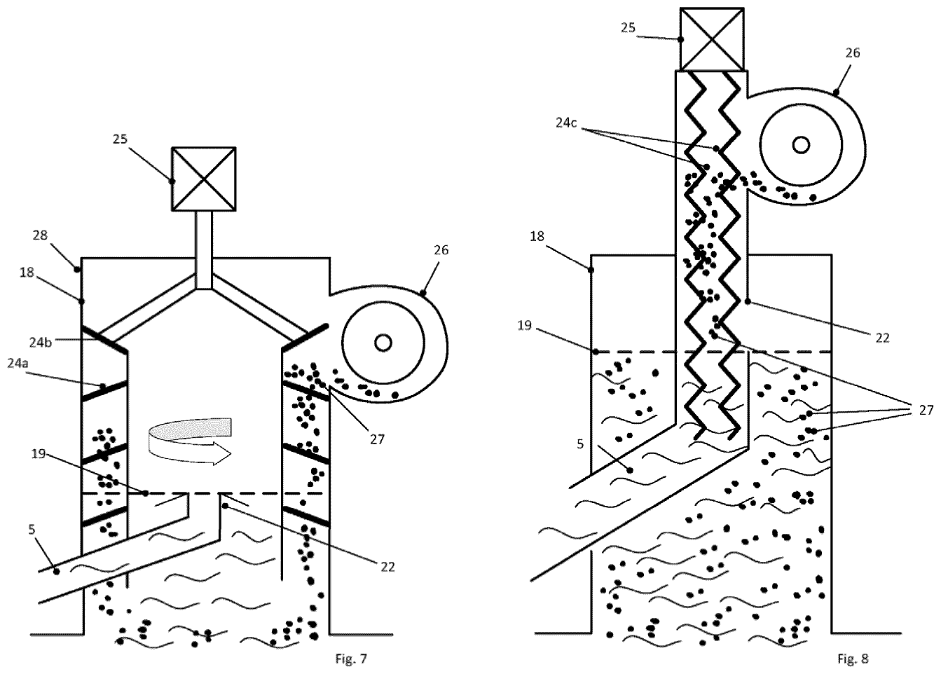

FIG. 7 to 9 show devices for mechanical separation in the dome 18.

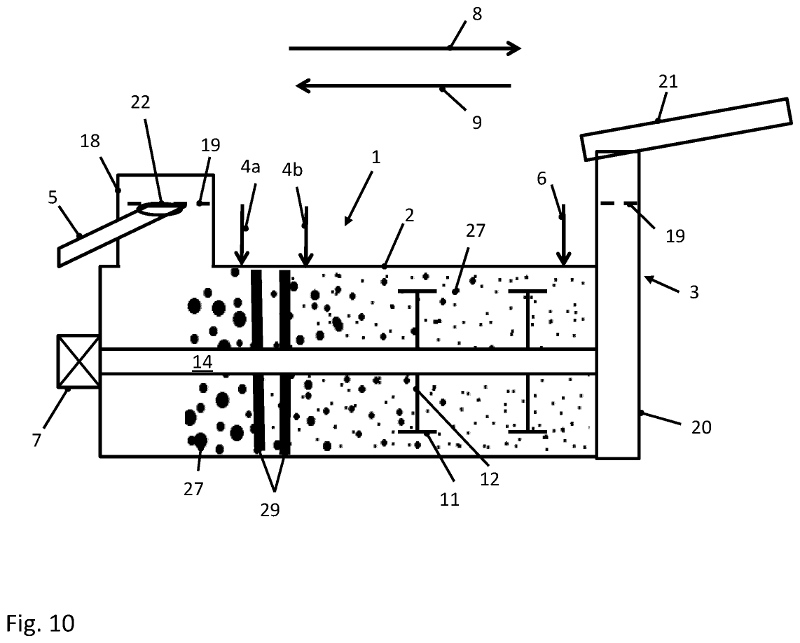

FIG. 10 shows a mixing kneader 10 comprising sealing discs 29 and two first input devices 4a, b.

With reference to FIG. 1 to 10, the mode of operation of the device according to the invention is explained as follows, wherein by way of example the extraction of water from SAP particles, and the replacement of the water, contained in the SAP, with ethanol, is described:

The working space 2 of the mixing kneader 1 is always completely filled. For the sake of clarity, this is indicated only in FIGS. 1, 4, 5, 6 and 10, but not in FIGS. 2 and 3, by SAP particles 27, of which only some are provided with reference signs. The SAP polymerizate is introduced into the working space 2 via the first input device 4. Here, the polymer is comminuted by the action of the bars 11 that mesh with one another. In this case, it should be noted that, in FIG. 1, due to the side view, only one of the two shafts 14 is visible. With regard to FIG. 3, it should be noted that the spacings between the meshing bars 11 of the two shafts 14 are not shown true to scale, but rather merely highly schematically.

The comminution of the polymer particles 27 in the working space 2 is indicated in FIG. 1. The particles are comminuted during their passage, in the direction of the arrow 8, towards the first discharge device 3. While the polymer passes through the working space 2, the water contained in the SAP particles 27 is replaced by ethanol, which is introduced into the working space 2 via the second input device 6. The ethanol passes through the working space 2 along the flow direction 9, and subsequently leaves the working space 2 via the second discharge device 5. The flow direction 9 is thus counter to the conveying direction 8.

Thus, a counterflow extraction takes place, wherein a concentration gradient always prevails along the flow direction 9, which gradient ensures that the water, bound in the pores of the SAP, is replaced by ethanol.

In the first discharge device 3, the SAP is discharged. In this case, the ethanol can already be removed, at least part, in a manner not shown here, for example by making use of gravity. It is also conceivable, however, to remove the ethanol only in a step that follows the discharging.

In FIG. 2, the conveying angle 13 is shown on the basis of a single bar 11. The remaining bars 11 and discs 12 have not been shown, for the sake of clarity. As mentioned in the above description, the conveying angle 13 can preferably be between 5° and 45°.

The mixing kneader 1 according to FIG. 5 differs from the mixing kneader 1 according to FIG. 1 to 4 by the dome 18 and the design of the first discharge device 3. Some details, in particular the shaft structures, have not been shown in FIG. 5, for reasons of clarity. The design shown in FIG. 5 can be achieved by means of single and twin-shaft mixing kneaders 1.

The mixing kneader according to FIG. 5 is filled, during operation, with the mixture to be processed, up to the filling level 19 indicated. Thus, not only is the working space 2 completely filled, but rather also a part of the dome 18 and the twin discharge screw 20. The second discharge device 5, located centrally in the dome 18, removes the ethanol, enriched with water, which enters the second discharge device 6 via the inlet opening 22. Since the SAP polymerizate is fed in via the first input device 4, upstream of the dome 18 (based on the conveying direction 8), and moves upstream, in the conveying direction 8, immediately after being fed in, it does not enter the dome 18. As a result, unintended discharge of the polymer, in particular immediately after the infeed, is prevented.

The twin discharge screw 20 conveys the comminuted polymer vertically upwards, wherein the ethanol flows back into the working space 2, due to gravity, as soon as the polymer has been conveyed to a height above the filling level 19. The twin discharge screw 20 transfers the polymer, to be discharged, to the mono-screw 21, which is arranged obliquely in such a way that any remaining ethanol can flow back in the direction of the working space 2, following gravity. Thus, separation and return of the ethanol takes place in the first discharge device 3, comprising two screws 20, 21, according to FIG. 5, which makes the process very economical.

The shaft 14 is preferably arranged horizontally. The twin discharge screw 20 is preferably arranged vertically. The mono-screw 21 is preferably arranged at an angle of at least 5° relative to the horizontal, wherein this angle is preferably at most 45°.

The dimensions of the dome 18 are preferably selected to be so large that the discharging of the extract solution via the second discharge device 5 does not produce any significant flow at the transition between the working space 2 and dome 18. A flow of this kind would possibly also convey polymer particles into the dome 18, which leads to clogging and loss of the polymer just introduced, and should be prevented.

A mixing kneader 1 according to FIG. 6, having a downwardly pointing dome 18, is in particular used if the density of the extraction material fed into the first input device 4 is less than the density of the extractant. As is already the case in FIG. 5, the illustration of numerous details, such as the shaft structures, is also omitted in FIG. 6, for reasons of clarity. While the mixing kneader 1 according to FIG. 5 is thus particularly suitable for treating sinking particles 27, the mixing kneader 1 according to FIG. 6 is preferably used if floating particles 27 are to be treated.

In the case of a mixing kneader 1 according to FIG. 6, the filling level 19 is set in a simple manner by the design of the siphon 23. The filling level 19 can, however, additionally, just as in the case of the mixing kneader 1 according to FIG. 1 to 5, be influenced by the selection of the operating parameters.

FIGS. 7 and 8 show a device for mechanical separation which is arranged in the dome 18 and comprises coils 24a, b, c and a screw 26. The coils 24a, b, c are associated with a motor 25. The dome 18 can be arranged on a mixing kneader (not shown in FIGS. 7 and 8), which is shown for example in FIG. 5.

The coils 24a, b according to FIG. 7 are part of device for mechanical separation of the particles 27 from the extractant to be discharged. The coils 24a, b are arranged in a housing 28 and rotate about an imaginary vertically extending longitudinal axis of the dome 18. The coils 24a serve as upward-conveying elements, which convey the particles 27 into the screw 26. Upward-conveying coils 24b ensure that particles 27 that rise too high in any case enter the screw 26. An inlet opening 22 of the second discharge device 5 is located within the housing 28. On the one hand, particles 27 are kept away from said inlet opening 22, in that the coils 24a, b convey said particles into the screw 26. On the other hand, it is conceivable to rotate the coils 24a, b so fast that the particles 27 are pushed outwards, i.e. in the direction of an inside wall of the dome 18, by centrifugal forces resulting from this rotation. Even if individual particles 27 do not enter the space between the housing 28 and the inside wall of the dome 18, but rather penetrate into the space located within the housing 28, then they are preferably moved, there, away from the centrally located inlet opening 22.

In the embodiment according to FIG. 7, the above-mentioned rotation of the coils 24a, b can also first ensure that the particles 27 move outwards (i.e. in the direction of the inside wall of the dome 18) on account of the centrifugal force, and there, when rising along said inside wall, enter the space between the inside wall and the housing 28, from where they are conveyed into the screw 26.

FIG. 8 shows an alternative embodiment, in which coils 24c are arranged in the interior of the second discharge device 5. Particles 27 penetrating into the discharge device 5 via the inlet opening 22 are transported by the coils 24c upwards into the screw 26. The coils 24c are configured as double coils.

The coils 24a, b, c are driven by a motor 25.

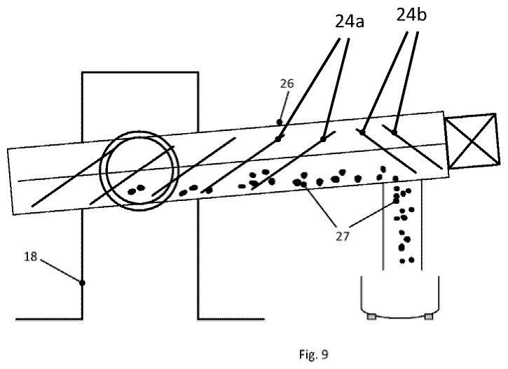

In FIG. 9, the screw 26, which adjoins the dome 18 in FIGS. 7 and 8, is shown in greater detail. After the coils 24a, b, c have introduced the particles 27 into the screw 26, said particles are transported upwards (i.e. to the right in FIG. 9) counter to the slight gradient of the screw 26. Any extractant that has penetrated into the screw 26 flows, following gravity, back (to the left in FIG. 9) into the dome 18. The particles 27 separated from any extractant can then be introduced into the mixing kneader 1 again, if they have left the screw 26 (far right in FIG. 9).

The particles 27 can be what are known as “fines”.

FIG. 10 shows a mixing kneader 1 which is similar to those according to FIGS. 1 and 5. For improved clarity, only two bars 11 and discs 12 are shown. The mixing kneader 1 comprises two first input devices 4a, 4b, between which two sealing discs 29 are located. If the extraction material is fed into the first input device 4a and if it is then observed that too much extraction material or extraction residue is entering the dome 18, in the flow direction 9, then exclusively the first input device 4b located to the right of the sealing disc 29 can be used for introducing the extraction material. A gap between the sealing discs 29 (shown only schematically) and the housing of the working space 2 is so small that, although extractant can pass through in the flow direction 9, particles 27 are held back.

Although only some preferred embodiments of the invention have been described and shown, it is obvious that a person skilled in the art can add numerous modifications, without departing from the essence and scope of the invention. In particular, the following variants and amendments are conceivable:

After discharge from the mixing kneader 1 that is shown, thermal and/or vacuum and/or mechanical drying, i.e. removal of the ethanol from the SAP, can take place. A separation by gravitation can already take place in the screws 20, 21. Further thermal and/or vacuum and/or mechanical drying can take place in a suitable device (not shown) which adjoins the screws 20, 21. Alternatively or complementarily, it is conceivable to heat at least one of the screws 20, 21, in order to remove the ethanol by evaporation. Expediently, at least one of the screws 20, 21 is then associated with a device for removal of the evaporated ethanol. If at least one of the screws 20, 21 is heated, then the evaporation energy required in a following drying process for removing the remaining ethanol is advantageously significantly reduced.

The filling level 19 can vary, as long as it is ensured that the working space 2 is completely filled. In particular the filling level 19 in the first discharge device 3 and, if present, in the dome 18 located above the working space 2, can thus be varied.

All the shown first discharge devices 3 can be configured in the form of two screws 20, 21, as is shown in FIG. 5. In this case, mechanical removal of the extractant from the mixture takes place preferably twice in succession, i.e. in each screw 20, 21. The ethanol is then preferably returned to the working space 2 in a suitable manner (not shown).

The input devices 4, 6 can be arranged at a suitable location of the periphery of the mixing kneader 1. It is not essential for the input devices 4, 6 to be arranged for example perpendicularly at the highest point of the mixing kneader 1.

The inlet opening 22 is preferably arranged centrally within the dome 18. In the centre of the dome 18, there is the highest likelihood of the liquid surface being as calm as possible and gentle discharge being made possible. However, the inlet opening 22 of the second discharge device 5 can also be located at another point in the dome 18, optionally also on the edge of the dome 18.

In all the variants, the input devices 4, 6 are preferably arranged in the portions 15, 16, even if these portions are not denoted separately.

Each mixing kneader 1 according to the present invention can comprise a plurality of first input devices 4a, 4b. The presence of two or more first input devices 4a, 4b can be independent of whether sealing discs 29 are provided on the shaft and between the first input devices 4a, 4b.

With respect to FIG. 5, it should be mentioned that the first input device 4 can for example also be arranged laterally further to the left in the figure, if there is little risk of the introduced suspension, in particular introduced particles 27, entering the dome 18. If this risk is particularly high, then the first input device 4 can also be arranged further to the right than shown in FIG. 5.

The inclination of the two screws 20, 21 can vary. The screw 20 can thus also deviate from a vertical arrangement, but preferably the two screws are oblique, i.e. arranged non-horizontally.

It is also conceivable to use just one screw 20. Furthermore, it is also conceivable for the screw 20, which can be operated alone or in combination with the screw 21, to be configured as a recovery twin screw.

The mixing kneader 1 and the longitudinal axis/axes extending through the at least one shaft 14 are preferably arranged horizontally.

The first input device 4 can comprise a nozzle, through which the suspension to be processes is pressed for the purpose of comminuting the polymer contained in the suspension.

It is clearly visible in FIG. 5 that the polymer particles 27 of the suspension, which are introduced into the working space 2 via the first input device 4, are moved in the conveying direction 8 of the polymer immediately after introduction, and do not drift “to the left” in the direction of the dome 18. What are responsible for the conveying “to the right” in FIG. 5 are the shaft structures (not shown there), in particular the discs and bars having the correspondingly selected conveying angles.

A sequence of the input and discharge devices 3, 4, 5, 6 along the longitudinal axis can deviate from the configurations shown. The further the first input device 4 is displaced in the conveying direction, the lower the likelihood of SAP particles, or in general the introduced reaction material, entering the second discharge device 5.

Radial and axial spacings exist between the input and discharge devices 3, 4, 5, 6 or between their connection points (inlet openings/outlet openings) and the working space 2. In this case, radial and axial relates to the longitudinal direction of the mixing kneader. Advantageous radial and axial spacings can be determined by tests.

Although the figures have been described exclusively in view of the extraction and the exchange of water from SAP polymerizate, the mixing kneader 1 shown in the figures can of course be used in other extraction methods. Merely by way of example, reference is made to the extraction of sulphur and sulphur compounds described in the section “Solution to the problem”.

Instead of the arrangement comprising the second discharge device 5 located in the dome 18, the alternative devices for mechanical separation, mentioned in the section “Solution to the problem”, are also conceivable. A mixing kneader 1 configured according to FIG. 6 does not necessarily have to comprise a siphon 23. The filling level 19 can also be set in another manner.

The components shown in FIG. 10 can be used in all the mixing kneaders 1 according to the invention. One or more sealing discs 29 can be provided. The sealing discs 29 can also be located between the second discharge device 5 and the first input device 4a that is located furthest to the left (with respect to the arrangement according to FIG. 10).

Irrespective of whether sealing discs 29 are used, the mixing kneader 1 can comprise one or more first input devices 4a, b. The further to the left, i.e. the closer to the second discharge device 5, that the extraction material is introduced, the longer it remains in the working space 2 and the more time is available for the extraction. In addition, the introduction of extraction material particles 27 into the second discharge device 5 is prevented more effectively the further to the right, i.e. the closer to the first discharge device 3, that the extraction material is introduced. If more first input devices 4a, b are available, then an operator can select the most suitable first input device 4a, 4b depending on process conditions. It is also conceivable to provide more than two first input devices 4a, 4b.

In FIG. 10, particles 27 are identifiable to the left of the two sealing discs 29. In this situation that is shown, it would therefore be appropriate to no longer introduce the extraction material via the first input device 4a, but rather via the right-hand first input device 4b, i.e. that which is located downstream in the conveying direction 8. In this way, it is possible to achieve the part of the working space 2 located further to the left, i.e. upstream of the sealing discs 29 in the conveying direction 8, remains largely particle-free.

If particles 27 are returned to the working space 2 again, via the screw 26 shown in FIG. 9, then the feed of these particles 27 preferably takes place in the first input device 4b arranged furthest to the right (with respect to FIG. 10).

The coils 24a, b, c can be configured to convey the particles 27 back into the working space, even without an adjoining screw 26.

List of reference signs

| | |
|---|---|
| 1 | Mixing kneader |
| 2 | Working space |
| 3 | First discharge device |
| 4 | First input device |
| 5 | Second discharge device |
| 6 | Second input device |
| 7 | Drive |
| 8 | Conveying direction of the |
| | extraction material |
| 9 | Flow direction of the extractant |
| 10 | Dispensing point |
| 11 | Bars |
| 12 | Discs |
| 13 | Conveying angle |
| 14 | Shaft |
| 15 | Input-side portion |
| 16 | Discharge-side portion |
| 17 | Kneading counter hooks |
| 18 | Dome |
| 19 | Filling level |
| 20 | Discharge twin screw conveyor |
| 21 | Mono-screw conveyor |
| 22 | Inlet opening |
| 23 | Siphon |
| 24 | Coil |
| 25 | Motor |
| 26 | Screw conveyor |
| 27 | Particle |
| 28 | Housing |
| 29 | Sealing disc |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |

1. Mixing kneader (1) for carrying out a continuous extraction, in which, with the aid of an extractant, at least one component is dissolved out of an extraction material, the mixing kneader (1) comprising
a working space (2),
at least one shaft (14) extending in the working space (2),
the at least one shaft (14) comprising shaft structures (11, 12, 29) in the form of kneading elements, wherein the shaft structures (11, 12, 29) of the at least one shaft (14) are configured to mesh, during operation, with the shaft structures (11, 12, 29) of at least one second shaft (14) or with stationary kneading elements (17) present in the mixing kneader (1),
a first input device (4) for feeding the extraction material into the mixing kneader (1), and
a first discharge device (3) which lies substantially opposite the first input device (4) and is intended for discharging the extraction residue,
by further comprising
a second input device (6) for feeding the extractant, wherein this second input device (6) is arranged substantially opposite the first input device (4),
a second discharge device (5) for discharging the extract solution, wherein the second discharge device (5) is arranged substantially opposite the first discharge device (3), wherein
the second discharge device (5) comprises a device for mechanical separation.

2. Mixing kneader (1) according to claim 1, wherein the first discharge device (3) comprises means for conveying the extraction material and the extraction residue, and at least one portion of the first discharge device (3) is arranged higher than the working space (2) of the mixing kneader (1), wherein the first discharge device (3) is configured to separate remaining extractant from the extraction residue by the effect of gravity.

3. Mixing kneader (1) according to claim 1, wherein the kneading elements (11, 17), which pass one another during ongoing operation, are at a minimum spacing from one another of 1 to 30 millimetres.

4. Mixing kneader (1) according to claim 1, wherein the at least one shaft (14) is configured to achieve a conveying direction (8) of the extraction material and of the extraction residue from the first input device (4) to the first discharge device (3), even though a flow direction (9) of the extractant runs opposingly.

5. Mixing kneader (1) according to claim 4, wherein conveying angles (13) of the bars are between 5° and 45°.

6. Mixing kneader (1) according to claim 1, further comprising a dome (18), in which the second discharge device (5) is located.

7. Mixing kneader (1) according to claim 1, wherein the first discharge device (3) comprises two discharge screws (20, 21) connected one behind the other.

8. Mixing kneader (1) according to claim 7, wherein at least one of the discharge screws (20, 21) is heatable.

9. Mixing kneader (1) according to claim 6, wherein the dome (18) is arranged under the working space (2), wherein the dome (18) is connected to a siphon (23), the highest point of which is located above the working space (2).

10. Mixing kneader (1) according to claim 1, wherein the dome (18) is arranged above the working space (2) and coils (24a, b, c) are arranged in the dome (18), in order to prevent penetration of particles (27) into the second discharge device (5).

11. Method for the continuous extraction of at least one component from an extraction material in a mixing kneader (1) according to claim 1, the method comprising the following steps:
feeding the extractant into the mixing kneader (1) via the second input device (6),
feeding the extraction material into the mixing kneader (1) via at least one first input device (4),
wherein the working space (2) is filled completely with the mixture to be processed, comprising the extraction material and the extractant,
wherein the extraction material or the extraction residue is conveyed effectively, with respect to an imaginary longitudinal direction of the at least one shaft (14), by the movement of the at least one shaft (14), from the first input device (4) to the first discharge device (3), and is discharged from the first discharge device (3),
wherein the extractant flows from the second input device (6) to the second discharge device (5), overcoming a conveying movement caused by the movement of the at least one shaft (14), and
wherein the extractant is selected in such a way that it dissolves or emulsifies or suspends or chemically modifies the at least one component to be dissolved from the extraction material, under the process conditions prevailing in the mixing kneader (1), and wherein
the extractant is furthermore selected such that it does not dissolve or emulsify the component of the extraction material remaining as extraction residue in all ratios of extraction material and extractant occurring in the mixing kneader (1), and wherein
the component of the extraction material remaining as extraction residue is selected such that it is present as a solid or as a highly viscous liquid at all ratios of extraction material and extractant occurring in the mixing kneader (1).

12. Method according to claim 11, wherein the extraction material is comminuted by the shaft structures (11, 12, 29), by the movement of the at least one shaft (14).

13. Method according to claim 9, wherein the extraction material has the same density as or a higher density than the extractant.

14. Method according to claim 9, wherein the extraction material has a lower density than the extractant.

15. (canceled)

16. Method according to claim 11, wherein the extractant does not dissolve or emulsify the component of the extraction material remaining as extraction residue after addition of a precipitant and/or a flocculant.

17. Method according to claim 11, wherein the component of the extraction material remaining as extraction residue is selected such that it is present as a solid or as a highly viscous liquid after addition of a precipitant and/or a flocculant.
